(19) United States
(12) Patent Application Publication
(10) Pub. No.: US 2015/0115573 A1
(43) Pub. Date: Apr. 30, 2015

(54) SELF-LOCKING COMPACT COUPLING

(71) Applicant: Zwei plus zwei GmbH, Köln (DE)

(72) Inventor: Derk Bossel, Zierenberg (DE)

(21) Appl. No.: 14/395,354

(22) PCT Filed: Apr. 18, 2013
(86) PCT No.: PCT/EP2013/058123

§ 371 Date: Oct. 17, 2014

(30) Foreign Application Priority Data
Apr. 18, 2012 (DE) 102012103404.4

(51) Int. Cl. B60D 1/145

(52) U.S. Cl. CPC B60D 1/145
USPC 280/504

(57) ABSTRACT

A coupling is provided for connecting a two-track trailer having at least one drawbar, to a non-motorized vehicle, or to a vehicle having an auxiliary drive, particularly a bicycle. The coupling has two interacting coupling parts releasable from one another and respectively connectable to the vehicle and to the drawbar. The coupling has a bolt having a cylindrical shell surface and a bushing or bolt guide, plugged onto the bolt and engaging at least partially around the bolt, as interacting coupling parts. The bushing or bolt guide has at least one opening for insertion of the bolt. The interconnected coupling parts are rotatable relative to one another about their common longitudinal axis and act as a rotary joint with one degree of freedom. The coupling parts have a lock to securely connect them together. On the drawbar, further joints impart the coupling with at least two further degrees of freedom.

### CROSS-REFERENCE TO RELATED APPLICATIONS

This application is a Section 371 of International Application No. PCT/EP2013/058123, filed Apr. 18, 2013, which was published in the German language on Oct. 24, 2013, under International Publication No. WO 2013/156578 A1 and the disclosure of which is incorporated herein by reference.

### BACKGROUND OF THE INVENTION

The invention relates to a coupling for connecting a trailer, which features at least one drawbar, to a non-motorized vehicle or to a vehicle which has merely an auxiliary drive, in particular to a bicycle or to a pedelec, having two interacting coupling parts which can be released from one another and of which one is connected in a positionally fixed manner to the vehicle and the other is connected to the drawbar.

Couplings for connecting the drawbar of a bicycle trailer to a bicycle are sufficiently well known. They are generally either attached to the bicycle frame in a central position underneath the saddle or attached to the seat post or laterally to the rear fork from the chain stay and seat stay or directly to the rear wheel of the bicycle.

A trailer coupling with a trailer ball to be attached to a bicycle frame below the saddle which can be inserted into a coupling body provided at the anterior end of a drawbar is known from German Utility Model Application DE 299 09 176 U1. The trailer ball is retained in a ball socket in the coupling body by a so-called safeguarding tube, which slides across the coupling body with the aid of a spring, which supports itself against the end of the drawbar. In order to insert the trailer ball into the coupling body or to detach the trailer ball from the coupling body, the safeguarding tube is pushed back against the spring force towards the bicycle trailer, so that the ball socket is freely accessible in the coupling body. One of the fundamental disadvantages of couplings of this kind is that the bicycle rack of the bicycle can no longer be used, or at least only in a very limited way, since the drawbar is carried via the bicycle rack. A further fundamental disadvantage is found in the relatively high force transmission point which significantly takes the load off the rear wheel of the bicycle when the trailer is pushed and can also lever out the bicycle.

Moreover, all couplings which are to be attached to the seat tube at the height of the seat stay have a significant practical disadvantage in that a safe and simple installation of couplings of this kind is often not possible due to the variety of different shapes and structures of frames.

A coupling for the lateral attachment of a bicycle trailer with a side-mounted drawbar to a bicycle frame, which features a drawbar connection part and a bicycle connection part connected thereto in a detachable fashion, is known from German published patent application DE 196 09 910 A1. When engaged, the drawbar connection part is attached to the bicycle connection part in an articulated fashion in at least three rotation axes. The coupling is configured as a plug-in coupling. It features a coupling bush as the first coupling part, which belongs to the drawbar connection part. In the coupling bush, spring-elastic tongues are arranged with latches. A bolt piece, which is a component of the bicycle connection part, works together with it as a second coupling part. The bolt piece can be inserted axially into the coupling bush until the catch springs engage in a circumferential groove of the bolt piece. The bolt piece can freely pivot in the bushing. The bicycle connection part features two further rotary joints, of which a first one is arranged at an angled end of a connector fixed to the chain stay and seat stay of a bicycle frame. The second rotary joint is located between the first rotary joint and the coupling and is connected to the first rotary joint by means of an offset piece. The comparatively high effort required to attach the coupling to the bicycle frame and the similarly high mass the bicycle has to carry along even when free of the trailer are disadvantages of this coupling. Also disadvantageous are the torsional moments which, because of the design, act on the mounting plate of the coupling on the side of the bicycle by thrusting and tugging movements, and which, in unfavorable cases, can lead to the detachment of the fastener which secures the mounting plate to the bicycle.

A further trailer coupling for a bicycle trailer is known from U.S. Pat. No. 6,099,088. It features a first coupling mounting part, arranged at the end of a quick-release hub and firmly connected to the quick-release unit, which is mounted with an anti-friction bearing on the first coupling mounting part and is rotatable around the longitudinal axis of the hub, as well as a second coupling mounting part arranged thereon, which has a socket for a plug bolt. The coupling-side end of the drawbar also features a socket for the plug bolt which interacts therewith. In order to connect the drawbar to the second coupling mounting plate, the bolt radial to the hub axle is introduced into the sockets. The drawbar can then be pivoted around the bolt axis. The drawbar is secured in the socket with the help of a locking spring. The coupling is exclusively designed for quick-release hubs and cannot be used for bicycles with solid axles.

### BRIEF SUMMARY OF THE INVENTION

The object of the invention is to provide a coupling of the kind stated at the beginning, which does not feature the above-mentioned disadvantages.

This object is achieved with a coupling of the kind stated at the beginning, comprising a bolt having a cylindrical shell surface and a bushing or bolt guide, which can be attached to the bolt and which at least partially encompasses the bolt as interacting coupling parts, wherein the bushing or bolt guide features at least one opening for the insertion of the bolt and wherein the coupling parts, which are connected to one another, are rotatable relative to one another around their common longitudinal axis and operate as a rotary joint with one degree of freedom. The coupling parts feature a lock, with which the coupling parts can be securely connected to one another, and on the drawbar side, further joints are provided, by which the coupling has imparted to it at least two further degrees of freedom.

A positionally fixed coupling part is to be understood here and in the following as a coupling part which does not alter its position relative to the vehicle frame. This does not exclude, however, the possibility that the positionally fixed coupling part may be pivoted around its longitudinal axis.

A bushing is to be understood here and in the following as a component which is suited to securely accommodate the bolt in a coupled state in relation to the position of its longitudinal axis. It can partially cover the bolt, but it can also simply consist of two or more ring-shaped borders for the bolt spaced axially to one another. It can be configured in such a way that locking means for securing the bolt in the bushing are also situated therein.

The positionally fixed coupling part can be both the bolt and the bushing for receiving the bolt. Both elements have the advantage that they can be easily attached in the area of the dropout of a bicycle frame or at the end of a wheel axle, for example, for instance by being screwed together, provided that they have the corresponding male or female thread, which either interact with the thread at the end of a wheel axle or with a screw counter-supported at the dropout.

The bolt of the coupling according to the invention can, depending on the design, be inserted into the bushing, for example, axially or radially to its longitudinal axis. In a preferred design, the lock ensures that the bolt is automatically securely retained in the bushing once the bolt has reached a certain position at insertion. If the bolt is inserted into the bushing and locked with the lock, the bolt and bushing are relatively mobile around their longitudinal axis, so that the part of the coupling composed of the bolt and bushing has one degree of freedom.

A further, drawbar-side joint, which can be, in particular, a cardanic joint, ensures that all movements of the drawbar can be accommodated by the coupling.

A further advantage of the coupling according to the invention is that only a minimum of coupling parts—only one single component, in a preferred design—remains on the vehicle if the coupling is detached at one point. Thus, the separation of the coupling happens at the provision of its—viewed from the vehicle—first degree of freedom. This is a particularly large advantage with respect to the coupling known from DE 196 09 910 A1, wherein almost all coupling parts necessary for the three degrees of freedom provided by the coupling remain on the vehicle, even if the coupling is detached. This is, however, also an advantage with regard to the coupling known from U.S. Pat. No. 6,099,008, wherein the separation of the coupling happens at its—counted from the bicycle—second degree of freedom.

Preferably, the bicycle-side coupling part is arranged axially to the axle of the wheel hub, and in addition preferably features an attachment to the end of a wheel hub. Advantageously this attachment can be such that the bushing features a female thread or the bolt features a thread hole in the direction of its longitudinal axis, with which the bushing or the bolt can be screwed onto an end of the wheel hub or onto a connecting bolt counter-supported on the vehicle. A further fundamental advantage of the invention becomes clear at this point. In this way, through the relative movement between bolt and bushing, no torsional moment can be applied to the vehicle-side coupling part. Therefore, it can optionally be screwed on beside a lug nut on the end of the wheel axle or even adopt the role of a wheel fastener, whether it be as a lug nut in the case of solid axles or as a counter nut in the case of quick-release hub axles.

If the coupling element on the side of the vehicle is of sufficient thickness, it can be configured to be relatively short, so that it hardly projects over the dropout of the vehicle frame.

In particular, with coupling parts according to the invention which are to be axially inserted into one another, it is advantageous if the bolt sits without backlash in the bushing, since a force transmission between bolt and bushing thereby takes place by means of the largest possible contact surface.

Moreover, the bolt can feature further advantageous design elements as a fastener for a solid axle or counter nut of a quick-release unit. Thus, the bolt can, for example, feature at least two surfaces parallel to one another on the cylinder unit encased by the bushing, which form a fixing surface for a tool with which the bolt can be screwed in. After this, it is no longer possible to unscrew the bolt in a locked state, whereby a simple, but effective, anti-theft device is achieved. The bolt can also feature a cylindrical section on the end face whereon the female thread is located, which acts as a spacer if the wheel axle is located in so-called 3D dropouts, which feature an indentation into which the wheel fastener projects. This ensures that the bolt can be installed safely and without damage, even in conditions with limited space.

A special design of the end face of the bushing accommodating the bolt can also be advantageous, in that the end face features an axial shaped sleeve which, in an attached and locked state, covers the mounting surfaces of the bolt to the extent that it is no longer possible to attempt to dismantle the bolt using a tool.

The coupling parts are axially attached to one another in a coupled state. In a preferred design of the invention, this is achieved in that one of the coupling parts features at least one at least partially circumferential shoulder or groove, which forms at least one first axially acting bearing surface, and on the other coupling part a counter bearing which interacts with the first axially acting bearing surface is provided. In particular, an element which interacts with the other coupling part is also to be taken into consideration for a counter bearing, for example a lock which preferably forms not just one axially acting bearing surface, but at least two axially acting bearing surfaces as a counter bearing, thereby locking the movement of the bolt in the bushing in both axial directions while interacting with the corresponding axially acting bearing surfaces of the one coupling part. In this way, it is possible to secure both coupling parts axially in both directions. Preferably, at the same time, the bearing surfaces lie inside the bushing or bolt guide when the bolt is put in the bushing or bolt guide, so that the coupling can have a compact structure.

In a constructively simple and therefore preferred embodiment of the invention, a duct for a locking pin is provided in the bushing, such that the locking pin located in the duct intervenes in a groove of a bolt inserted into the bushing, and, as a counter bearing, secures it against slipping out axially from the bushing. Thereby, in a further preferred embodiment, the bushing can be constructed in a laterally symmetrical way, as the duct for the locking pin is arranged centrally in the bushing. It is thereby possible to attach the bushing to the bolt from both faces of the bushing.

In an embodiment of the invention which is simplified in operation and is, in this respect, a preferred embodiment, the lock is configured in such a way that it automatically locks in place when the bushing is attached to the bolt and connect the coupling parts securely to one another. In addition, an unlocking mechanism is provided in order to unlock the lock, so that the coupling parts can be detached from one another. The coupling according to the invention is consequently configured as a plug coupling which is closed automatically due to the lock, which automatically locks in place, without requiring further handles. Thereby, unlike those from U.S. Pat. No. 6,099,008, the coupling parts can mostly be connected to one another single-handedly and by one handle.

For this purpose, the counter bearing can primarily be a spring-elastic element and/or spring-mounted, and can operate as a lock which automatically locks in place. The counter bearing can thus be formed by spring-mounted latches which are securely connected to one of the coupling parts and which, in a coupled state, intervene in an at least partially circumferential groove in the other coupling part.

If an at least partially circumferential groove is provided in the bolt, in a further preferred embodiment, two brackets can be provided inside the bushing as counter bearings, which are arranged transversely therein and on both sides of the longitudinal axis of the bushing. The brackets can optionally be formed as spring-elastic and/or spring mounted. If the bolt is inserted between the spring-mounted or spring-elastic bracket inside the bushing, it is retained in the bushing from opposite sides and is therefore optimally secured against slipping out axially from the bushing. Even in such an embodiment, but not only then, it is advantageous if the end of the bolt to be pushed into the bushing is tapered, in particular at an angle of approximately 45°. It can then be pressed in with its end between the spring-mounted or spring-elastic bracket, whereby the brackets push apart from one another and lock in place when the end position in the at least partially circumferential groove in the bolt has been reached. In principle, it is generally also possible to simply provide a spring-elastic formed or spring-mounted bracket in the bushing which only intervenes in the groove from one side, and then secures the bolt against axially slipping out or shifting in a similar way to a locking pin.

If a circumferential groove is provided inside the bushing, retaining balls, for example, can be provided at the bolt, which, as soon as they reach the circumferential groove when the bolt is inserted into the bushing, engage therein and thereby secure the bolt against slipping out of the bushing. This operating principle can also be implemented in reverse, with the groove in the bolt and spring-mounted retaining balls in the bushing.

In another preferred form, the lockcan feature a pre-stressed catch element on the bushing side, which is released as soon as the bolt is inserted into the bushing. The catch element can be, for example, a bracket, which firstly vacates the way to insert the bolt into the bushing and then, after release, encompasses the bolt, in a similar way to the latch of a car boot lock. In a case such as this, it can also be advantageous if the bolt features a shoulder at its end instead of a groove, which engages in the bushing in a corresponding recess. In this case, the bushing is to be shaped in such a way that the bolt can be inserted transverse to the longitudinal axis of the bushing.

Particularly when the bolt is connected to the vehicle in a positionally fixed manner, the bushing is at least partially open at at least one of its faces, so that the bolt can be inserted into the bushing. Thereby, the bolt is preferably inserted axially into the bushing. Depending on the embodiment of the coupling it can, however, likewise be advantageous if the bushing features a recess in its side, through which the bolt can be inserted into the bushing transverse to the longitudinal axis of the bushing. When the bushing is connected to the vehicle in a positionally fixed manner, an opening on the face of the bushing can be spared if the lateral surface of the bolt, rather than its face, is connected to the drawbar, and if the lock is such that it retains the bolt securely against sliding out of the side opening of the bushing.

The drawbar-side coupling part, of course, preferably features one or more further articulating means, so that the degree of freedom of the coupling is larger than 1. Thus, a first rotary joint, connected to the drawbar-side coupling part and in particular positioned thereon, for example, can be provided, the rotation axis of which runs essentially orthogonally to the longitudinal axis of the bolt. In a simplified design, this first rotation joint is formed in such a way that the bushing contained therein is formed in a laterally symmetrical way in order to receive the bolt, while the lock bolt is centrally arranged in the bushing. To supplement this, a further second rotary joint connected to the bushing, in particular adjacent to the first rotary joint, can be provided, the rotation axis of which runs orthogonally to that of the first rotary joint and the longitudinal axis of the bolt. This results in a particularly compact design, if the rotation axis of the first rotary joint intersects the longitudinal axis of the bolt.

As an alternative or in addition to the one or more described successive rotary joints of the drawbar-side coupling part, an elastic or spring-elastic connecting element arranged transverse to the longitudinal axis of the coupling parts, in particular a coil spring and/or an elastomer joint, can be provided between the drawbar and the drawbar-side coupling part.

In another preferred embodiment, the coupling according to the invention features a casing into which the bushing is inserted, and on which the first rotary joint and/or the connecting element are configured.

Moreover, in a further preferred embodiment, a lockable lock designed to obstruct the unlocking mechanism or to secure both coupling parts in the casing can be provided in the casing as theft protection.

In order to ensure a very simple operation of the coupling according to the invention, the unlocking mechanism features at least one actuator button with which the lock, which automatically locks in place, can be detached from one another, in particular by a single operation, so that the coupling agents can be separated from each other. Here, for example, a mechanism is suitable which causes one or more pins to be engaged in the lock by operation of the push button, and they then move them against their effective direction so that the bolt in the bushing is once again released.

The coupling according to the invention is particularly suitable for attaching bicycle trailers to bicycles, including those with an (electric) auxiliary drive. It is advantageous if the two coupling parts which can be detached from one another are either arranged parallel to the longitudinal axis of a rear wheel hub of the vehicle or aligned with the longitudinal axis of this wheel hub.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

FIG. 1 shows a drawbar with a coupling according to the invention arranged at one of its ends with a symmetrical bushing in a perspective view;

FIG. 2 shows the coupling according to the invention of the drawbar represented in FIG. 1 in a different perspective view;

FIG. 3 shows the coupling according to the invention represented in FIGS. 1 and 2 without the casing shell in a further perspective view;

FIG. 4 represents the coupling in the perspective view shown in FIG. 3 with a transparent representation of the shell of a subsequent joint;

FIG. 5 represents an embodiment of the coupling according to the invention with a casing accommodating the bushing in a perspective view;

FIG. 6 shows a different perspective view of the coupling according to the invention represented in FIG. 5;

FIG. 7 shows a third perspective view of the embodiment represented in FIG. 5 without the casing shell;

FIG. 8a shows a perspective view of the bushing represented in FIGS. 5 to 7 without the surrounding casing shell;

FIG. 8b shows a partial view of the locking mechanism represented in FIGS. 7 and 8a; and

FIG. 9 shows a further partial view of the embodiment represented in FIGS. 5 to 8.

### DETAILED DESCRIPTION OF THE INVENTION

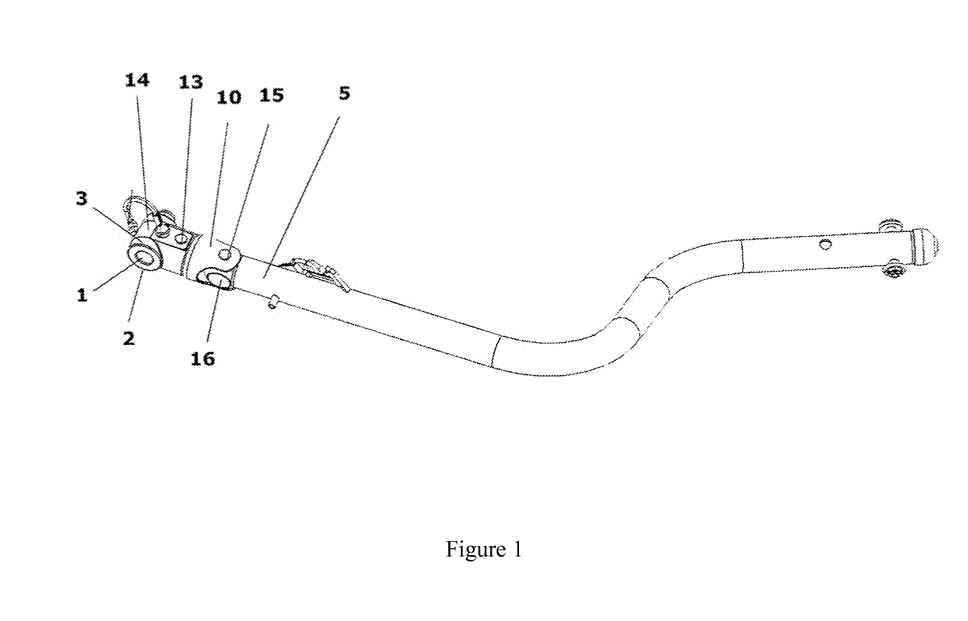

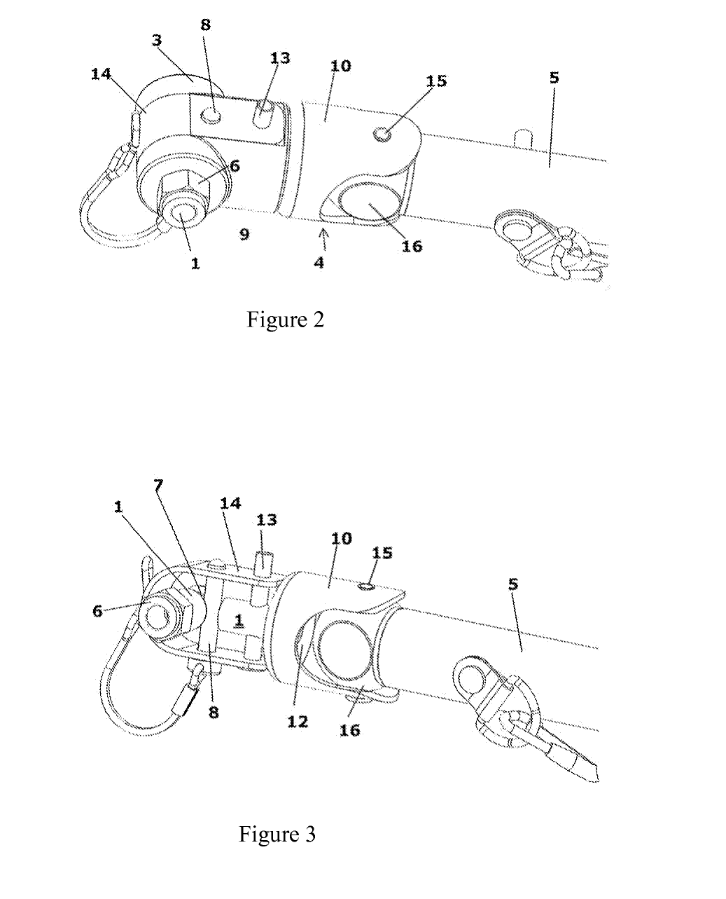

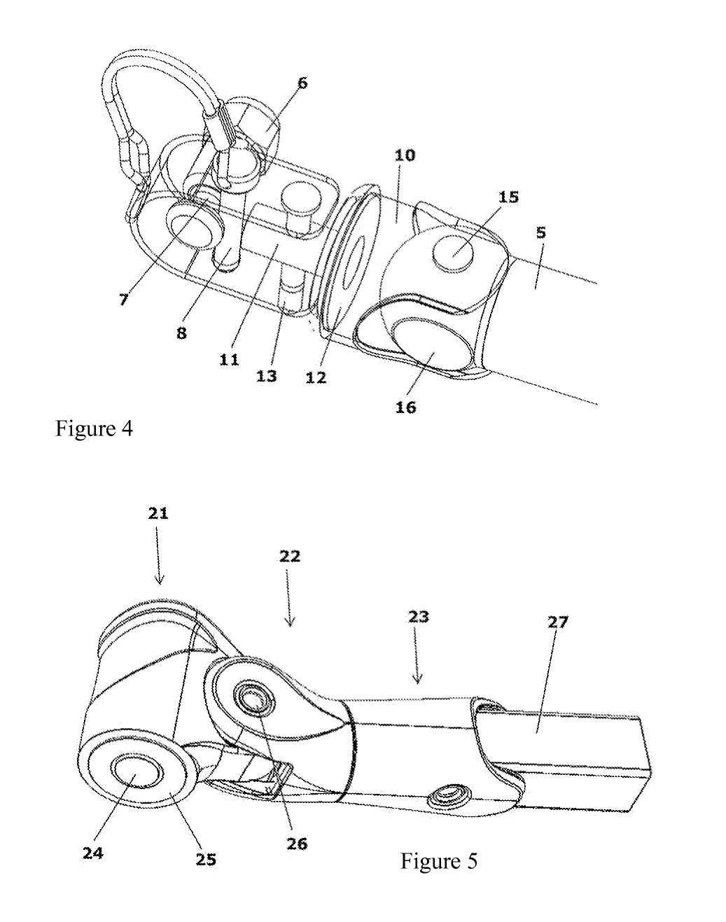

FIGS. 1 to 4 represent a first, constructively simple embodiment of the coupling according to the invention. While FIG. 1 shows a comprehensive view of a drawbar with a coupling arranged at its head from one perspective view, FIG. 2 shows the symmetrically formed head of the drawbar with the coupling from a different perspective. FIG. 3 represents the drawbar head together with the coupling from a further perspective, whereby the casing of the coupling is not represented in order to better represent the assembly and configuration of the degree of freedom or of the rotary joints required for its realization. Lastly, FIG. 4 shows the drawbar head together with the coupling in yet another perspective. Herein, in order to achieve a better representation of the structure of the coupling, only the casing was omitted and the shell of a subsequent joint of the coupling was represented as transparent.

The embodiment according to the invention features a vehicle-side, essentially rotationally symmetrical bolt 1, which is located in a drawbar-side bushing 2. The bushing 2 is a component of a casing 3. A cardanic joint combination 4 is joined to the casing transverse to the longitudinal axis of the bolt 1, by which the casing 3 is connected to the drawbar 5.

Bushing 2 and bolt 1 form a rotary joint, the rotation axis of which is preferably arranged in alignment with a rear wheel axle of the vehicle and so runs in the horizontal plane. The rotation axes of the joint combination 4 joined to the casing run orthogonally to one another and to the longitudinal axis of the bushing 2, so that the coupling has three degrees of freedom.

As is particularly obvious in FIGS. 2 to 4, the end of the bolt 1 facing the vehicle is configured as a nut 6. For this reason, the bolt 1 is screwed onto the end of an axle of a rear wheel of a vehicle, in particular onto the rear wheel axle of a bicycle, and can even replace a conventional lug nut.

A circumferential groove 7 is provided in a central area of the bolt 1. A locking pin 8, which is inserted in a detachable fashion into the casing 3 and secures the bolt 1 against axial shifting, engages in this groove. Drilled holes aligned with one another are provided in the casing for the insertion of the locking pin, and the bushing 2 features an opening in the area of the encroachment of the locking pin 8 in the groove 7 of the bolt 1. The head of the locking pin 8 is secured to the casing 3 with a strap.

The locking pin 8 is retained in a section 9 of the casing 3 extending transverse to the longitudinal axis of the bolt 1. The front-side end of this casing section 9 is formed as a punched disc, as well as the front side of an associated shell section 10 lying flat against it for the joint combination 4. Through the punched discs, a further bolt 11 is effective, at one end of which a disc 12a is arranged, which lies flat against the inside of the punched disc of the shell section 10. The bolt 11 is secured in the casing 3 by a pin 13 embedded therein, which is inserted through the bolt 11. With this arrangement, the shell section 10 lies flat against the casing 3 and is rotatable towards the casing 3 around a rotation axis defined by the bolt 11, so that the coupling hereby receives a second degree of freedom. The rotation axis of the shell section 10 runs orthogonally to the longitudinal axis of bolt 1 and intersects it.

The casing 3, which mainly consists of a plastic, is reinforced by a metal, U-shaped bracket 14, which surrounds the casing section accommodating the bushing 2 and the casing section 9 joined to the side, and in particular reinforces the drill holes provided in the casing for the locking pin 8 and the pin 13, and secures the pins against a breakaway from the casing.

The shell section 10 accommodates the hinge piece 15 of a further rotary joint, whose counterpart is composed of the drawbar head 16. The rotation axis of the hinge piece 15 runs orthogonally to the longitudinal axis of the bolt 1 and to the rotational axis defined by the bolt 11. Thereby, the coupling has a third degree of freedom.

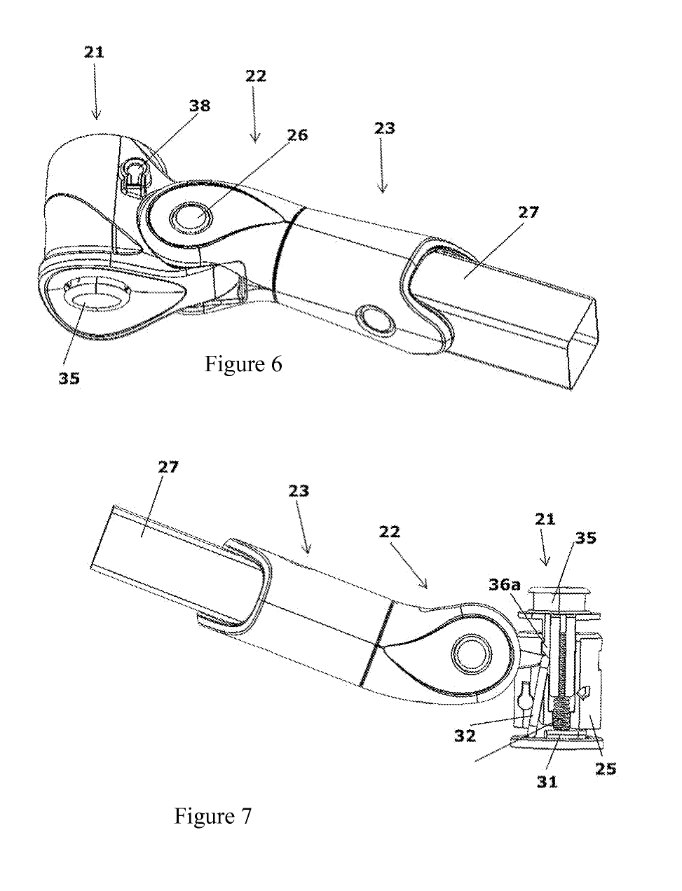

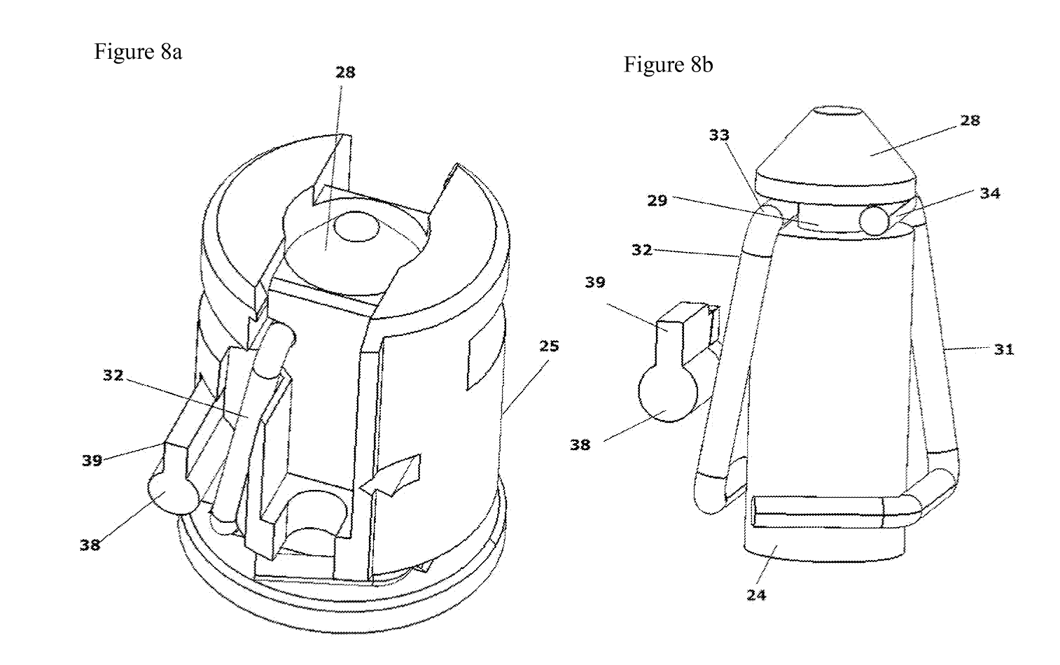

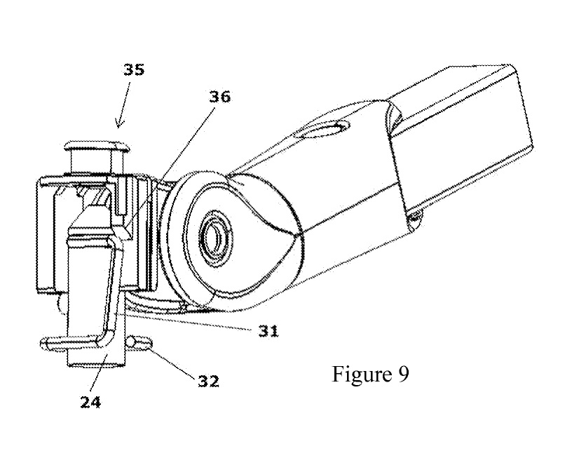

While the exemplary embodiment from FIGS. 1 to 4 is a constructively simple embodiment of the coupling according to the invention, the embodiment represented in FIGS. 5 to 9 is more sophisticated in its structural design, but, as a result, this considerably simplifies the operation. FIGS. 5 and 6 show different perspective views of the drawbar head together with the coupling according to the invention. FIG. 7 represents a further perspective view of the drawbar head along with the coupling; here, however, the coupling casing is not represented. FIG. 8a shows the bushing of the coupling represented in FIGS. 5 to 7 with a bolt inserted therein, as well as a section of the locking means which secure the bolt in the bushing, and a section of a deadbolt. FIG. 8b corresponds to the representation from FIG. 8a, but here the bushing is not illustrated. Finally, FIG. 9 shows the drawbar head together with the coupling from FIGS. 5 to 7, where, for explanatory purposes, the coupling casing and the bushing are not represented.

The coupling of this second embodiment presented in FIGS. 5 to 9 can be divided into three sections; a coupling head 21, an intermediate piece 22 and a drawbar head 23.

The coupling head 21 accommodates a bolt 24 attached to the vehicle in a bushing 25, in which the bolt 24 is mounted in a rotatable fashion. The coupling head 21 and intermediate piece 22 are connected to one another by a pivot bolt 26, the axis of which is arranged orthogonally to the axis of the bolt 24. The intermediate piece 22 and the drawbar head are connected to one another by means of a further pivot bolt (not represented), which is arranged axially to the end of the drawbar 27 and orthogonally to the pivot bolt 26. So, the coupling has three degrees of freedom.

As can be noted in FIG. 8b in particular, the bolt 24 features a bolt head 28 which is configured as a truncated cone and tapers off at an angle of 45° towards the tip. Behind the bolt head 28, the bolt features a circumferential groove 29. Otherwise, the illustrated section of bolt 24 is cylindrical. The vehicle-side end of the bolt is not presented in any of the FIGS. 5 to 9. It can, for example, be configured as a nut, just like the end of the bolt 1 from the embodiment represented in FIGS. 1 to 4. In particular, the preferred hexagonally configured installation edge can be once again cylindrically tapered at the vehicle-side end of the bolt in order to establish a kind of distance sleeve.

An automatically engaging lock is provided in the bushing 25 for securing of the bolt 24. As can be noted from FIGS. 8a and 8b in particular, the lock essentially encompasses two spring clips 31, 32 with frame-like ends 33, 34 mounted on the exterior of the bushing 25 which, in recesses of the bushing 25 provided for this purpose, reach into the bushing at opposite sides from outside, and to such an extent that they can engage in the circumferential groove 29 of the bolt 24. When the bolt 24 is inserted into the bushing 25, bolt head 28 first, the frame-like ends 33, 34 of the spring clips 31, 32 are pushed apart by the truncated cone and then automatically lock into place in the circumferential groove 29, so that the bolt 24 can no longer be automatically axially extracted from the bushing 25.

An unlocking mechanism is provided for the release of the coupling. The unlocking mechanism features a push button 35 guided axially to the longitudinal axis of the bolt 24 in the coupling head 21, which can be operated against a spring force (spring not represented). The push button features two unlocking digits 36, which act on the spring clips 31, 32 and, upon operation of the press button, push them apart so that their frame-like ends 33, 34 release the circumferential groove 29 of the bolt 24 and the bolt 24 can be removed from the bushing 25.

In addition, this embodiment of the coupling according to the invention features a lock 38, with the frame 39 of which, one of the spring clips 31 can be blocked against being unlocked if it is in a closed position, so that the coupling cannot be released.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1.-31. (canceled)

32. A coupling for connecting a two-track trailer that comprises at least one drawbar to a non-motorized vehicle or to a vehicle which has merely an auxiliary drive, the coupling comprising:
two interacting coupling parts which can be released from one another and of which one is connected in a positionally fixed manner to the vehicle and the other is connected to the drawbar;
a bolt having a cylindrical shell surface and a bushing or bolt guide which can be attached to the bolt and which at least partially encompasses the bolt as interacting coupling parts, wherein the bushing or bolt guide comprises at least one opening for the insertion of the bolt and the coupling parts, which are connected to one another, are rotatable relative to one another around their common longitudinal axis and operate as a rotary joint with one degree of freedom,
wherein the coupling parts feature a lock, with which the coupling parts can be securely connected to one another, and
wherein, on a drawbar side, further joints are provided, by which the coupling has imparted to it at least two further degrees of freedom.

33. The coupling according to claim 32, wherein one of the coupling parts comprises at least one at least partially circumferential shoulder or groove, which forms at least one first axially acting bearing surface, and the coupling further comprising a counter bearing on the other coupling part, wherein the counter bearing is configured to interact with the first axially acting bearing surface.

34. The coupling according to claim 33, wherein the counter bearing is composed of an element configured to interact with the lock.

35. The coupling according to claim 33, wherein the lock forms at least two axially operating counter bearing surfaces and is configured to inhibit movement of the bolt in the bushing in both axial directions.

36. The coupling according to claim 33, wherein the bearing surfaces lie inside the bushing or bolt guide if the bolt is put into the bushing.

37. The coupling according to claim 36, further comprising a duct in the bushing for a locking pin, such that if the locking pin is disposed located in the duct the locking pin is arranged to intervene in a groove of the bolt inserted into the bushing, and, as a counter bearing, secures it against slipping out axially from the bushing.

38. The coupling according to claim 32, wherein the lock is formed in such a way that it automatically locks in place when the bushing is attached to the bolt and connects the coupling parts securely to one another, and wherein the coupling further comprises an unlocking mechanism configured to unlock the lock, so that the coupling parts can be detached from one another.

39. The coupling according to claim 38, wherein the unlocking mechanism comprises at least one actuator button with which the lock can be unlocked by a single operation, so that the coupling agents can be separated from each other.

40. The coupling according to claim 33, wherein the counter bearing is a spring-elastic element and/or spring-mounted, and operates as a lock.

41. The coupling according to claim 40, wherein the counter bearing comprises spring-mounted latches.

42. The coupling according to claim 33, wherein the counter bearing comprises two parallel spring-elastic and/or spring-mounted brackets in the bushing, which are arranged transversely and on both sides of a longitudinal axis of the bushing.

43. The coupling according to claim 32, wherein the bolt is tapered at an end to be pushed into the bushing.

44. The coupling according to claim 32, wherein the lock comprises a pre-stressed catch element on a bushing side, which is released as soon as the bolt is inserted into the bushing.

45. The coupling according to claim 32, further comprising a recess in a side of the bushing, through which the bolt can be inserted into the bushing transverse to a longitudinal axis of the bushing.

46. The coupling according to claim 32, wherein a vehicle-side coupling part is to be arranged axially to an axle of a wheel hub or parallel thereto.

47. The coupling according to claim 46, wherein the vehicle-side coupling part comprises an attachment to an end of the wheel hub or to a connecting bolt counter-supported on the vehicle.

48. The coupling according to claim 47, wherein the bushing or the bolt comprises a drill hole having a thread in a direction of its longitudinal axis, with which it can be screwed onto the end of the wheel hub or onto the connecting bolt.

49. The coupling according to claim 48, wherein the coupling part to be screwed onto the wheel hub simultaneously performs the role of a lug nut.

50. The coupling according to claim 32, wherein the bushing encompasses the bolt without backlash.

51. The coupling according to claim 32, wherein a vehicle-side coupling part is the bolt, which comprises an edge as a spacer at its end pointing towards the vehicle, which has a cylindrical form.

52. The coupling according to claim 32, wherein the bolt is primarily cylindrical and comprises at least two surfaces parallel to one another and incorporated into the cylinder for attachment of a tool.

53. The coupling according to claim 32, further comprising a first rotary joint connected to the bushing and positioned thereon, a rotation axis of which runs essentially orthogonally to a longitudinal axis of the bolt.

54. The coupling according to claim 45, wherein the bolt comprises a shoulder on an end face turned away from the vehicle.

55. The coupling according to claim 54, wherein the shoulder comprises at least two incorporated surfaces each parallel to one another for attachment of a tool.

56. The coupling according to claim 53, further comprising a second rotary joint connected to the bushing, adjacent to the first rotary joint, a rotation axis of which second rotary joint runs orthogonally to that of the first rotary joint and the longitudinal axis of the bolt.

57. The coupling according to claim 53, wherein the rotation axis of the first rotary joint intersects the longitudinal axis of the bolt.

58. The coupling according to claim 32, further comprising an elastic connecting element arranged transverse to a longitudinal axis of the coupling parts between the drawbar and the drawbar-side coupling part.

59. The coupling according to claim 56, further comprising a casing into which the bushing is inserted, and on which the first rotary joint and/or a connecting element is configured.

60. The coupling according to claim 32, wherein the lock is configured as a lockable lock or to obstruct the unlocking mechanism.

61. A system of a vehicle and a vehicle trailer comprising one drawbar having a coupling according to claim 32 to connect the drawbar to the vehicle.

62. The system according to claim 61, wherein a longitudinal axis of the interacting coupling parts is arranged such that it is parallel to a wheel axle of the vehicle or aligned therewith.
